(19) United States
(12) Patent Application Publication
(10) Pub. No.: US 2009/0167180 A1
(43) Pub. Date: Jul. 2, 2009

(54) Electric Lamp

(75) Inventors: Jürgen Gräf, Augsburg (DE); Peter Husslein, Günzburg (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRÄNKTER HAFTUNG, Munchen (DE)

(21) Appl. No.: 12/225,592

(22) PCT Filed: Mar. 13, 2007
(86) PCT No.: PCT/EP2007/052342

§ 371 Date: Sep. 25, 2008

(30) Foreign Application Priority Data
Mar. 28, 2006 (DE) 10 2006 014 294.2

(51) Int. Cl. H01J 61/36; H01J 9/00

(52) U.S. Cl. 313/623; 445/43

(57) ABSTRACT

The invention relates to a novel lamp which comprises a pinched base (10) that interacts with a screw cap. A pump hole (21) is integrated into the pinched base.

### TECHNICAL FIELD

The invention is based on a high-pressure discharge lamp in accordance with the preamble of claim 1. Such lamps are in particular high-pressure discharge lamps for general lighting or else for photooptical purposes.

### PRIOR ART

U.S. Pat. No. 5,550,422 has disclosed a high-pressure discharge lamp in which the outer bulb of the discharge vessel is joined to the screw-type base without the use of cement. In this case, however, a round shape of the end of the outer bulb is of course still made to approximate the round shape of the screw-type base.

### DESCRIPTION OF THE INVENTION

The object of the present invention is to provide a high-pressure discharge lamp which is inexpensive and easy to manufacture.

This object is achieved by the characterizing features of claim 1.

Particularly advantageous configurations are given in the dependent claims.

The invention specifies a high-pressure discharge lamp in which a novel closing technique is used for the fitting of the base which results in a reduction in manufacturing costs. The particular advantage of this solution is moreover that the exhaust quality is improved.

Until now, such lamps have been manufactured with plate-like fuse seals, exhaust tubes and usually also cementing of the base sleeve. The novel solution results in a reduction in the number of components and production aids and therefore also a reduction in processes, such as, for example, elimination of the plate manufacturing process. In addition, there is a reduction in the complexity involved in the production as a result of the replacement of processes which are difficult to control, such as, for example, the replacement of the cementing of the base by mechanical fastening, in particular by simple crimping.

Specifically, the electric lamp according to the invention has a tubular bulb, which is closed at a first end with a circular-cylindrical base, at least one power supply line being passed through the first end in a gas-tight manner. In this case, the first end facing the base is sealed off with a pinch seal, with an exhaust hole being integrated in the pinch seal, which exhaust hole is closed again when the lamp is finished. The pinch seal has two narrow sides and two broad sides. Possibly, the pinch seal is in the form of an I or a double T, as is known per se.

The base is fastened on the pinch seal without the use of cement, in particular with the aid of crimping. In this case, it is held mechanically, for example simply by means of crimping. Preferably, an improved hold is achieved by virtue of part of the first end being marched, on its surface, to the base resting there. Particularly preferably, a correspondingly shaped cylindrical collar is provided at the first end and/or the narrow sides of the pinch seal are matched to the dimensions of the base.

Usually, the base is a pin-type base or a screw-type base. The improved mechanical hold is particularly effective in the case of a screw-type base because the thread can be partially post-formed on the surface of the first end. This helical screw then improves the hold of the thread of the screw-type base engaging there. A short cylindrical collar is particularly suitable for this purpose. In the case of a short physical length, each narrow side can instead also be provided with a threaded cutout.

In general, two leadthroughs are passed through the pinch seal at the same time, with in particular one of the leadthroughs being arranged more centrally and one leadthrough being arranged to the side thereof. In the case of pin-type bases, it is better for the leadthroughs to both be arranged to the side, while the exhaust hole is central.

Typically, the second end of the bulb is closed by a rounded or pointed dome. However, it is also possible for a leadthrough to be positioned there and to be passed to the outside.

Typically, the lamp is a high-pressure discharge lamp with an outer bulb. However, it may also be a discharge vessel which is fitted directly with a base. In addition, the invention can be applied to incandescent lamps.

Often, the exhaust hole is arranged axially parallel. It can, however, also be positioned at an angle or even be bent, for example in the form of a Z, if the circumstances demand it.

The invention also proposes a process for manufacturing an electric lamp, wherein first the internals are introduced, then the open end of the bulb is evacuated and filled with purging gas at approximately atmospheric pressure, then the open end is closed with a pinch seal, the internals having electrical feed lines passing to the outside which are also enclosed in the pinch seal, and, during the pinch-sealing process, the internal pressure in the bulb being increased temporarily, with the pinch-sealing being carried out, in particular by means of temporary insertion of a conical, water-cooled hollow pin, in such a way that an exhaust hole remains in the pinch seal, with the result that the bulb can, if necessary, then be evacuated or filled through the exhaust hole, with the exhaust hole finally being closed.

In this case it is recommended that, during the pinch-sealing, part of the end is shaped in such a way that it is matched to the shape of the screw-type base.

A simple technique for the closing operation is for the exhaust hole to shut by itself, in particular if there is a subatmospheric pressure prevailing in the bulb, or to be closed by means of a pinch seal.

A particular advantage of the invention is the improvement in the exhaust quality, since, according to the invention, the exhaust hole is integrated in the pinch seal. Thus, the exhaust cross section can be selected to be larger and the exhaust hole length can be selected to be extremely short, both of which improve the efficiency. The exhaust tube length has until now typically been dimensioned such that the inner diameter is 4-6 mm and the length of the exhaust tube is approximately 100-120 mm. Thus, cleaning and evacuation as well as filling are achieved only in a very arduous manner and incompletely. An exhaust hole in the pinch seal can have a larger diameter and a substantially shorter delivery length.

In particular, the end of the bulb which faces the base is now provided with a pinch seal, with the narrow sides of the pinch seal being matched in a form-fitting manner to the base. Generally, not only are the two power supply lines passed through the pinch seal but at the same time a capillary is contained therein, which capillary acts as an exhaust hole. The capillary may be axially parallel, with the result that it is short and effective. For particular purposes, it may also be positioned at an angle with respect to the axis or have a curved shape.

Thus, a circular-cylindrical base, generally a screw-type base, can be fastened in a simple manner without the use of cement by virtue of, for example, a crimping technique being used, as is known per se. In principle, such a technique is known, for example, from DE-A 103 36 282. Specifically, for a crimp fastening, one or both narrow sides can have a hollow, into which a lug of the sheet-metal material for the base is pressed. A pin-type base, as is conventional in the case of fluorescent lamps, can also be fastened in this simple way.

Preferably, the end of the bulb has a short circular-cylindrical piece which has a helical furrowing like a screw-type base. The base can be screwed thereon and additionally locked by crimping. Alternatively or in addition, a section of the helical furrowing can be integrally formed on the narrow sides of the pinch seal. As a result, the base is mechanically fixed and finally locked by means of the crimping.

Furthermore, contact is preferably made with the power supply lines without the use of solder. For this purpose, a centrally arranged power supply line is designed to be solid and ends in a button-like contact. This then rests as a central contact piece on the end of the base and replaces the so-called base platelet (eyelet).

Preferably, but not necessarily, a foil is dispensed with in the pinch seal and instead hard-glass technology with direct leadthrough is used. This system is known per se. A suitable system is, for example, a power supply line which ends in a special leadthrough. Outside the pinch seal, the leadthrough is connected to an outer power supply line. This usually takes place by means of welding.

The second outer power supply line is preferably bent back towards the outside, to be precise towards the adjacent narrow side. Advantageously, a groove is fitted there, into which groove the end of the power supply line is bent back. This makes simple clamping contact on the base possible. Improved contact can be achieved by means of welding.

Dispensing with a foil or with two foils provides enough space within the pinch seal for an exhaust hole which is particularly effective. First the bulb, which is preferably the outer bulb of a lamp and which is preferably closed at one end, is evacuated at its initially still open first end over its entire cross-sectional area. Owing to the large cross-sectional area, this is so effective that in this way for the first time it is no longer absolutely necessary for a getter to be provided in the outer bulb, with the result that the cost of manufacture is thereby reduced and, under certain circumstances, any shadowing as a result of the getter no longer occurs. This is a milestone in the manufacture of lamps with outer bulbs.

This technique can of course not only be used in high-pressure discharge lamps but also in halogen incandescent lamps etc. The technique is in principle also suitable for direct fitting of a base on a single bulb.

With the above provisions, simple fitting of a base without the use of a base insulator and without cement is possible in a very simple manner. The number of components for a lamp can therefore be reduced by almost half. This breakthrough was only possible as a result of a radical deviation from the concept of the base and the end of the bulb which is anchored in the base being given a similar shape.

Thus, not only the complex plate, which enlarges the physical length, but also an extra exhaust tube can be dispensed with. Instead, after purging of the bulb through the open first end during manufacture of the pinch seal, an exhaust hole is integrated in the pinch seal at the open first end, and this exhaust hole is then sufficient for filling the bulb with the desired filling and also for generating a vacuum, if desired.

Any conventional glass can be used as the material for the bulb, i.e. in particular hard glass, soft glass, soda-lime glass with a corresponding known leadthrough technique, possibly also vycor or quartz glass using foils. The choice of filling in this bulb is not subject to any particular restriction either.

### BRIEF DESCRIPTION OF THE DRAWINGS

The invention will be explained in more detail below with reference to a plurality of exemplary embodiments. In the figures:

FIG. 1 shows a high-pressure discharge lamp;

FIG. 2 shows the lamp from FIG. 1 before the base is fitted, in a side view (FIG. 2a) and in cross section (FIG. 2b);

FIG. 3 shows a further exemplary embodiment of an end of a lamp once the exhaust hole has been closed, in a side view (FIG. 3a) and rotated through 90° (FIG. 3b) and in a perspective view (FIG. 3c);

FIG. 4 shows a further exemplary embodiment of an end of a lamp;

FIGS. 5-6 show further exemplary embodiments of an end of a lamp.

### PREFERRED EMBODIMENT OF THE INVENTION

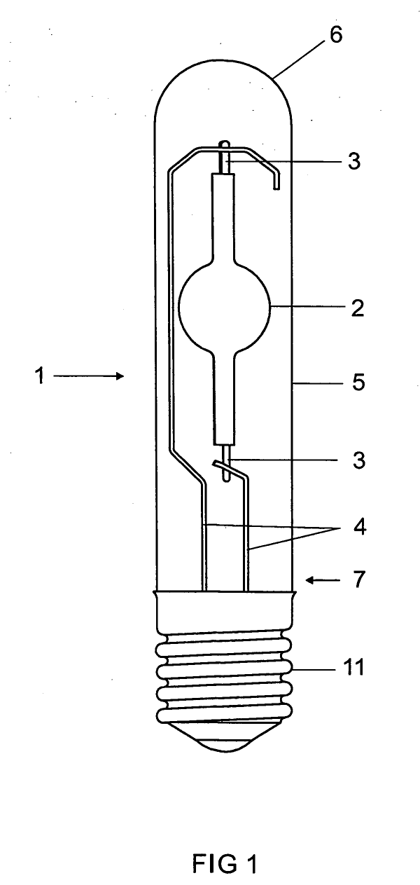

FIG. 1 shows a discharge lamp 1 with a base fitted. It comprises a discharge vessel 2 made from quartz glass, ceramic or else hard glass, into which two electrodes (not shown) are inserted. They are connected to power supply lines 3, which protrude out of the discharge vessel. These power supply lines are fastened on frame parts 4. The discharge vessel with the frame is introduced in a tubular outer bulb 5. The end 6 thereof which is remote from the base is closed with a dome, in which the frame is fixed. The end 7 close to the base, through which end the frame parts 4 are passed to the outside, is closed by means of a pinch seal 10. This is shaped in such a way that a conventional screw-type base 11 can be fastened thereon without the use of cement.

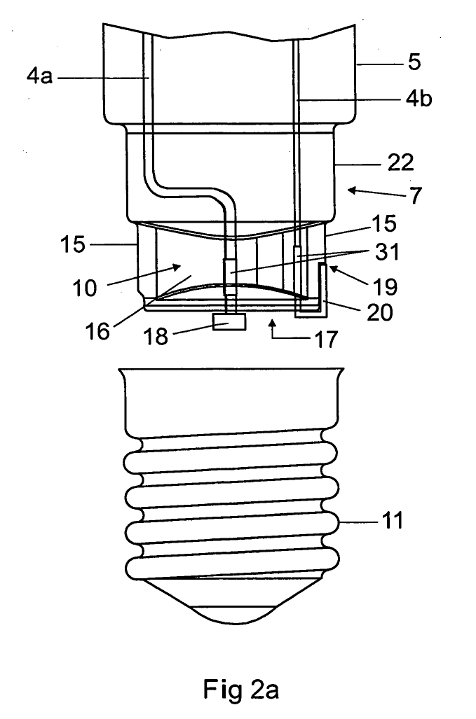

FIG. 2 shows the pinch-sealed end 7 in detail. The pinch seal 10 has two narrow sides 15 and two broad sides 16 as well as an end face 17. The first line 4a, which is in this case a frame part, but may also be a leadthrough or the like, is passed centrally towards the outside at the end face 17 and ends in a contact button 18. The second line 4b is passed towards the outside to the side thereof and, outside the pinch seal 10, is bent back in the form of a U towards the outside. Preferably, the pinch seal is in the form of an I, with the result that the narrow sides 15 are slightly broader than the thickness of the broad sides 16. The end 20 of the second line 4b is in this case fitted into a groove 19 in the narrow side and therefore fixed provisionally.

During the pinch-sealing, in addition an exhaust hole 21 is kept free between the two lines 4a, 4b, and later the bulb 5 can be evacuated or filled further still in a targeted manner through said exhaust hole 21. In particular, the pressure of the argon used initially as purging gas can be adjusted in a suitable manner for this purpose. In addition to argon, nitrogen or a combination of the two or else an argon/neon mixture or the like is also suitable as filling gas.

The narrow sides 15 are in this case smooth as for conventional pinch seals. In this exemplary embodiment, the end 7 also comprises a smooth collar 22, on which the end of the base 11 can rest with an accurate fit.

FIG. 2b illustrates a cross section through the pinch seal 10, with the exhaust hole still being open. This exhaust hole is later closed with glass.

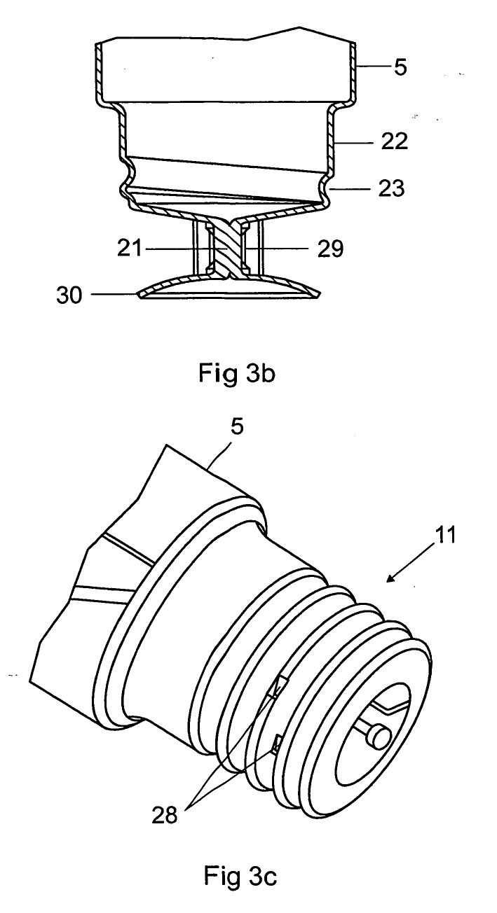

FIG. 4 shows an exemplary embodiment in which the pinch seal 10 is matched in terms of its shape to the screw-type base 11 so as to have a good hold. This means not only the diameter of the pinch seal but also preferably a furrowing 25 on the narrow sides which is matched to the helical thread of the screw-type base 11. Lugs 36 are provided on the base which are pressed inwards. In each case two lugs 36 fix a narrow side 15 by means of a crimping operation.

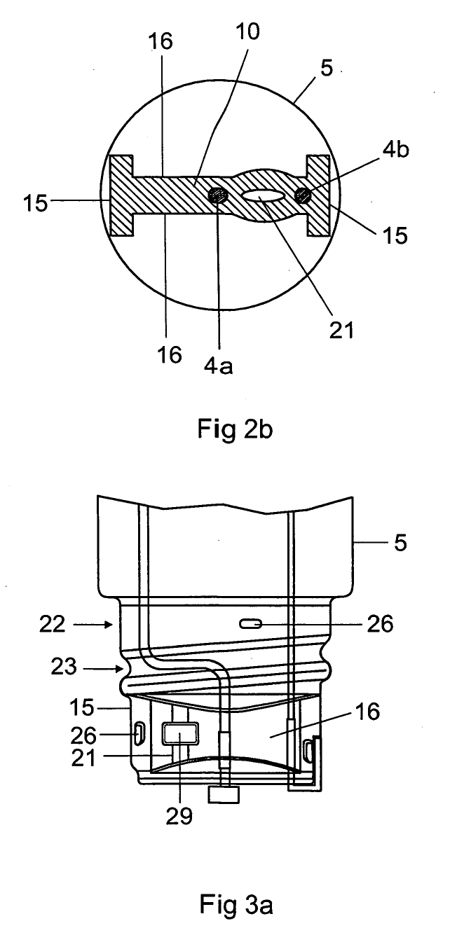

Alternatively, as shown in FIG. 3, a collar 22 with a cylindrical cross section is used, and a thread 23 is formed into the base-side end thereof. A combination of the two measures is also possible. In a further embodiment, such matching measures are not used.

Preferably, also as shown in FIG. 3, cutouts 26 in the form of small hollows are applied to the narrow sides 15 of the pinch seal and to the collar 22, and these cutouts 26 can interact with stamped-out portions 28 on the screw-type base 11. These are pressed into the hollows shown in FIG. 3c, which makes it possible for the base 11 to be locked on the end of the lamp in a very simple manner without the use of cement.

FIG. 3 also shows that the exhaust hole 21 rests to the side in the pinch seal and, once the bulb 5 has been filled, for its part is closed by a stamp-like pinch seal 29; see also in this regard the cross section at the level of the exhaust hole in FIG. 3b. After the pinch-sealing, a flange 30 is also still retained, which flange makes it easier for the base to be fitted.

The tubular bulb can of course also have a bulged shape. It is merely essential that its base-side end is circular-cylindrical. If necessary, a plurality of exhaust holes can also be used.

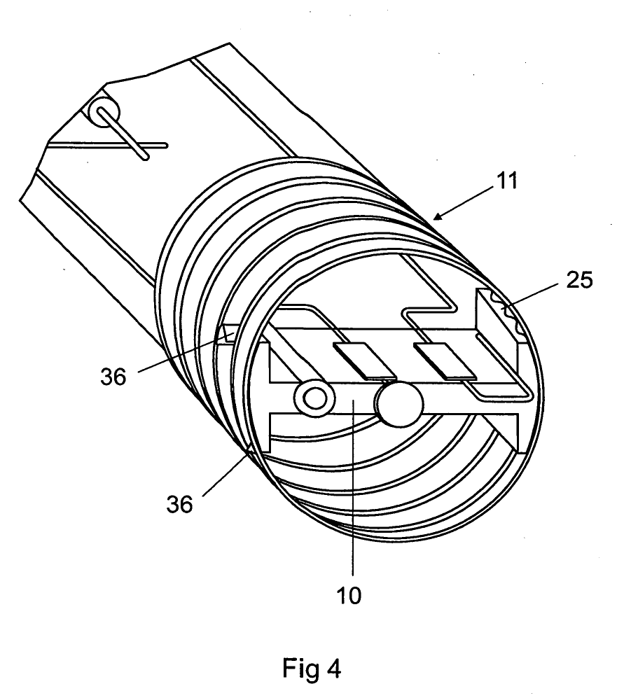

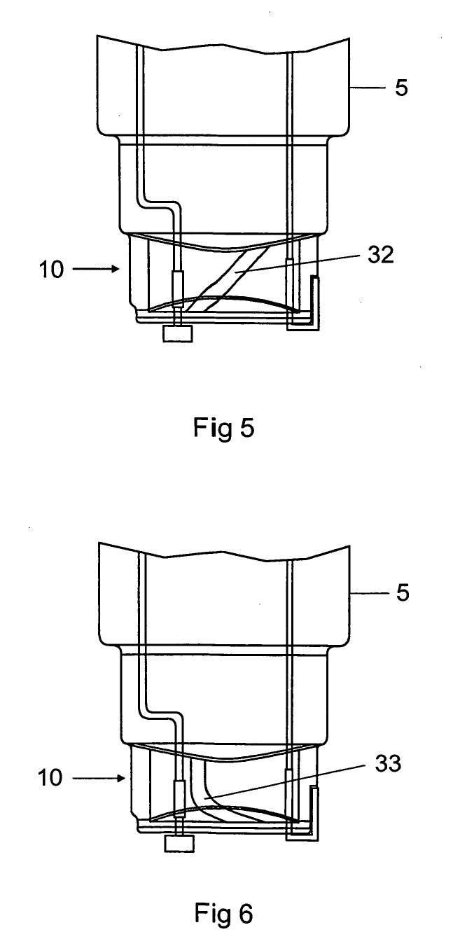

FIG. 5 shows an exhaust hole 32, which is arranged at an angle in the pinch seal 10. FIG. 6 shows an exhaust hole 33, which is arranged with a curvature in the pinch seal.

The manufacturing process proceeds in such a way that first the internals are introduced into the bulb which is closed at one end at the second end for example with a dome, i.e. the frame with the electrodes or the luminous element, or the inner vessel, which is fastened on a frame. In this case, the two ends of the leadthroughs are connected, at the level of the future pinch seal, to line parts 31 which are suitable for being sealed off in the pinch seal. Then, the open first end of the bulb is evacuated over its entire cross section and filled with purging gas at approximately atmospheric pressure. Preferably, argon is used for this purpose. Then, the open base-side first end is closed with a pinch seal, the internals having line parts passing to the outside, possibly also foils in the case of quartz glass as the material for the bulb, which are also enclosed in the pinch seal. In this case, the internal pressure in the bulb is temporarily increased during the pinch-sealing process via the exhaust hole or its precursor. In this case, the pinch-sealing process is carried out in such a way that an exhaust hole remains in the pinch seal. This takes place in particular by virtue of a slightly conical, water-cooled hollow pin being inserted temporarily at the location of the future exhaust hole, with the result that the hollow pin is also enclosed in the pinch seal and can then be withdrawn easily. The internal volume of the bulb can therefore then be evacuated or filled both through the hollow pin and possibly through the exhaust hole. Finally, the exhaust hole itself is closed by virtue, for example, of it either shutting by itself if there is a subatmospheric pressure prevailing in the bulb or of it being closed by an additional pinch seal 29, for example at the level of the center of the exhaust hole.

1. An electric lamp having a tubular bulb, which is closed at a first end with a circular-cylindrical base, at least one electrical line being passed through the end in a gas-tight manner, characterized in that the first end facing the base is sealed off with a pinch seal, with an exhaust hole being integrated in the pinch seal.

2. The lamp as claimed in claim 1, characterized in that part of the first end is matched, on its surface, to the base resting there.

3. The lamp as claimed in claim 2, characterized in that a correspondingly shaped cylindrical collar is provided at the first end and/or in that the narrow sides of the pinch seal are matched to the dimensions of the base.

4. The lamp as claimed in claim 1, characterized in that the base is fastened on the pinch seal without the use of cement, in particular with the aid of crimping.

5. The lamp as claimed in claim 1, characterized in that the base is a pin-type base or a screw-type base.

6. The lamp as claimed in claim 1, characterized in that two lines are passed through the pinch seal, with in particular one of the lines being arranged centrally and one line being arranged to the side thereof.

7. The lamp as claimed in claim 1, characterized in that the second end of the bulb is closed by a dome.

8. The lamp as claimed in claim 1, characterized in that the lamp is a high-pressure discharge lamp with an outer bulb.

9. The lamp as claimed in claim 1, characterized in that the exhaust hole is arranged axially parallel.

10. A process for manufacturing an electric lamp, characterized in that first the internals are introduced, then the open end of the bulb is evacuated and filled with purging gas at approximately atmospheric pressure, then the open end is closed with a pinch seal, the internals having electrical lines passing to the outside which are also enclosed in the pinch seal, and, during the pinch-sealing process, the internal pressure in the bulb being increased temporarily, with the pinch-sealing being carried out, in particular by means of temporary insertion of a conical, water-cooled hollow pin, in such a way that an exhaust hole remains in the pinch seal, with the result that the bulb can, if necessary, then be evacuated or filled through the exhaust hole, with the exhaust hole finally being closed.

11. The process as claimed in claim 9, characterized in that, during the pinch-sealing, part of the end is shaped in such a way that it is matched to the shape of the screw-type base.

12. The process as claimed in claim 9, characterized in that the exhaust hole shuts by itself or is closed by means of a pinch seal.
